(19) United States
(12) Patent Application Publication
(10) Pub. No.: US 2026/0244473 A1
(43) Pub. Date: Aug. 20, 2026

(54) PROCESS-IN-MEMORY (PIM) VIRTUALIZATION WITH TRANSLATION LAYER

(71) Applicant: QUALCOMM Incorporated, San Diego, CA (US)

(72) Inventors: Subbarao Palacharla, San Diego, CA (US); Christopher Lott, San Diego, CA (US); Girish Bhat, San Diego, CA (US)

(21) Appl. No.: 19/059,019

(22) Filed: Feb. 20, 2025

(51) Int. Cl. G06F 9/455; G06F 9/46; G06F 9/50; G06F 15/78

(52) U.S. Cl. CPC G06F 9/45504; G06F 9/461; G06F 9/5038; G06F 15/7807

(57) ABSTRACT

A translation layer in a memory controller enables virtualization of Process-In-Memory (PIM) operations across multiple system-on-chip (SoC) clients. The translation layer provides virtual PIM interfaces to different SoC clients, allowing each client to interact with what appears to be its own dedicated PIM unit. When SoC clients submit PIM operation requests through their virtual interfaces, the translation layer translates and interleaves these requests into operations for the physical PIM unit in the memory device. This architecture supports context switching between clients by storing and restoring operational states, manages resource allocation through arbitration, and maintains consistent interfaces across different PIM hardware implementations. The virtualization approach enables efficient sharing of PIM resources in heterogeneous computing environments while preserving isolation between clients.

### TECHNICAL FIELD

This disclosure relates generally to wireless communication, and more specifically, to virtualization of processing-in-memory (PIM) operations in system-on-chip (SoC) architectures through translation layer implementations.

### BACKGROUND

Modern computing systems, particularly in mobile and edge devices, increasingly rely on artificial intelligence (AI) applications that demand intensive matrix computations and high memory bandwidth. Processing-in-memory (PIM) architectures have emerged as an effective solution to address memory bandwidth constraints by performing computations directly within memory devices. In PIM architectures, computational units integrated within Dynamic Random Access Memory (DRAM) enable matrix-vector operations to be executed where the data resides to leverage better internal memory bandwidth compared to traditional architectures, which require data transfer between memory and processor.

PIM units in DRAMs typically implement a single hardware context to minimize area overhead on cost-sensitive DRAM dies. The hardware context generally comprises essential computational elements including a vector register, multiplication accumulation (MAC) units, and an accumulator register. The components support fundamental matrix operations required for, e.g., AI workloads and other computationally intensive tasks.

Contemporary mobile computing systems are rapidly transitioning toward heterogeneous AI architectures, where AI functions are distributed across multiple compute subsystems within a system-on-chip (SoC). Such subsystems typically include central processing units (CPUs), graphics processing units (GPUs), and neural signal processors (NSPs), each requiring access to PIM capabilities. Sharing a single PIM hardware context across multiple SoC clients presents significant technical challenges. For instance, direct sharing of PIM resources between subsystems can lead to operational conflicts and functional errors including, e.g., corrupted register states and incorrect accumulator results when multiple clients attempt simultaneous access.

Existing approaches to PIM resource management in heterogeneous computing environments struggle to maintain consistent performance. The complexity of coordinating PIM access across multiple SoC clients while preserving computational accuracy and efficient resource utilization is a technical challenge in known architectures. Embodiments described herein address such technical challenges through innovative virtualization approaches.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes systems, methods, devices, and apparatuses for virtualization of processing-in-memory (PIM) operations in system-on-chip (SoC) architectures through translation layer implementations. The systems, methods and devices of this disclosure each have several innovative aspects, no single one of which is solely responsible for the desirable attributes disclosed herein.

One innovative aspect of the subject matter described in this disclosure can be implemented in an apparatus for virtualizing Process In Memory (PIM) operations. The apparatus includes a system-on-chip (SoC) including one or more SoC clients, a memory controller comprising a translation layer, and a memory device comprising a process-in-memory (PIM) unit and configured for communication with the SoC via the memory controller. The translation layer is configured to provide one or more virtual PIM interfaces to the one or more SoC clients, wherein the one or more virtual PIM interfaces is associated with the one or more SoC clients, receive one or more PIM operation requests from the one or more SoC clients via the one or more virtual PIM interfaces, and translate the received one or more PIM operation requests into one or more PIM operations and interleave the one or more PIM operations.

In some examples, the PIM operation requests may include various operations such as writing data to a vector register in the PIM unit, performing multiply-accumulate operations using data stored in the PIM unit, reading from an accumulator register in the PIM unit, executing matrix-vector multiplication operations, conducting element-wise vector operations, or performing reduction operations on data stored in the PIM unit. The translation layer enables consistent virtual PIM interfaces across different hardware implementations and can accommodate various PIM architectures. The SoC clients may include processing units such as CPUs, GPUs, or NPUs.

In some implementations, the memory controller arbitrates requests from the SoC clients and grants time-based access to the PIM unit for each of the SoC clients, potentially assigning priorities to these requests. The translation layer manages context information for each SoC client, including temporary accumulator results and register states associated with incomplete PIM operations, and handles context switching between clients by storing current context information for a first client and retrieving previous context information for a second client. Additionally, the translation layer can combine multiple PIM operation requests into a single optimized operation and translate this combined operation into a single set of instructions for the PIM unit.

Another innovative aspect of the subject matter described in this disclosure can be implemented in a method for operating a memory controller comprising a translation layer, the memory controller operable in an apparatus for virtualizing Process in Memory (PIM) operations. The method includes providing, by the translation layer, one or more virtual process-in-memory (PIM) interfaces, each virtual PIM interface associated with a respective system-on-chip (SoC) client of the apparatus, receiving, by the translation layer, one or more PIM operation requests from one or more SoC clients via the one or more virtual PIM interfaces, and translating and interleaving, at the translation layer, the received one or more PIM operation requests into one or more PIM operations.

In some examples, the method includes enabling consistent virtual PIM interfaces across hardware implementations, managing different types of PIM operation requests, and coordinating access among various processing units. The method involves arbitrating requests from each of the SoC clients, granting access to the PIM unit for a time period, and assigning priorities to these requests. The method also supports combining multiple requests into a single optimized operation and translating this combined operation into a single set of instructions for the PIM unit.

Another innovative aspect of the subject matter described in this disclosure can be implemented in an apparatus for virtualizing PIM operations. The apparatus includes a system-on-chip (SoC) including one or more SoC clients, a memory controller comprising a translation layer, and a memory device comprising a process-in-memory (PIM) unit configured for communication with the SoC via the memory controller. The translation layer comprises a context manager configured to store first context information for a first SoC client in response to detecting a switch to a second SoC client, wherein the context information includes at least one of temporary accumulator results or register states associated with PIM operations, retrieve second context information for the second SoC client, store the second context information to the PIM unit before processing a PIM operation request from the second SoC client, and translate the PIM operation request into one or more PIM operations for execution by the PIM unit.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

These and other implementations may each optionally include one or more of the following features. For instance, various implementations may include one or more of: parallel processing capabilities, different memory configurations, various block sizes, different bit-width combinations, and different scaling factor arrangements.

The various aspects, implementations, and features disclosed herein may be implemented in a variety of ways. For example, aspects may be implemented as a device, such as a processing-in-memory device, a memory controller, or an integrated circuit. Aspects may also be implemented as one or more methods or processes. Further, aspects may be implemented as instructions stored in a computer-readable storage medium that, when executed by one or more processors, cause the processors to perform the disclosed operations. Such computer-readable storage media may include, but are not limited to, random access memory (RAM), read-only memory (ROM), electrically erasable programmable read-only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium capable of storing instructions for execution by processors.

The various aspects may also be implemented in hardware, software, firmware, or any combination thereof. For instance, aspects may be implemented as dedicated circuits or logic configured to execute the described functionality. Alternatively or additionally, aspects may be implemented as programs, modules, routines, or other software components executed by one or more processors. In some implementations, aspects may be implemented using application-specific integrated circuits (ASICs), field-programmable gate arrays (FPGAs), or other programmable logic devices.

The details of one or more implementations are set forth in the accompanying drawings and description below. Other features and advantages will be apparent from the description and drawings, and from the claims. It is to be understood that both the foregoing general description and the following detailed description are exemplary and explanatory only and are not restrictive of the invention, as claimed. Features shown in the various figures can be combined and/or modified in ways not explicitly shown, while remaining within the scope of the claims.

### DESCRIPTION OF THE FIGURES

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a processing-in-memory system that can be configured for virtualizing PIM operations across multiple SoC clients through translation layer implementations according to aspects described herein.

FIG. 2A shows a block diagram illustrating a basic PIM DRAM architecture that can support virtualization of PIM operations through translation layer management according to aspects described herein.

FIG. 2B shows an operational flow diagram illustrating matrix-vector multiplication processes within the virtualized PIM architecture according to aspects described herein.

FIG. 3A shows an operational flow diagram illustrating how a translation layer can be configured to enable virtualization of PIM operations across multiple SoC clients according to one or more aspects of this disclosure.

FIG. 3B shows an operational flow diagram illustrating how a translation layer can be configured to efficiently manage context switching between multiple virtual PIM interfaces according to one or more aspects of this disclosure.

FIG. 4 shows a flow chart of an example process performable by an apparatus for virtualizing Process In Memory (PIM) operations through translation layer implementations according to aspects described herein.

FIG. 5 illustrates a block diagram of an apparatus configured to virtualize Process-In-Memory (PIM) operations according to one or more aspects of this disclosure.

FIG. 6 shows a flow chart of an example process performable by an apparatus for virtualizing Process In Memory (PIM) operations through context-aware translation layer management according to aspects described herein.

FIG. 7 illustrates a block diagram of an apparatus configured to manage context switching in Process-In-Memory (PIM) operations according to one or more aspects of this disclosure.

Like reference numbers and designations in the various drawings indicate like elements.

### DETAILED DESCRIPTION

The present disclosure provides systems, apparatus, methods, and computer-readable media that support virtualization of process-in-memory operations, particularly techniques for efficiently sharing PIM resources across multiple system-on-chip (SoC) clients through a translation layer. Shortcomings of previous techniques mentioned here are only representative and are included to highlight problems that the inventors have identified with respect to existing process-in-memory devices and sought to improve upon.

As previously discussed, modern mobile computing systems are increasingly moving towards heterogeneous AI architectures where AI functions are distributed across multiple compute subsystems within a system-on-chip (SoC). Process In Memory (PIM) units in DRAMs typically support only a single hardware context to minimize area overhead on cost-sensitive DRAM dies, including a vector register, MAC units, and an accumulator register. Sharing a single PIM hardware context across multiple SoC clients (CPU, GPU, and NSP) can lead to functional errors during operation. As such, there is a need for improved systems, methods, devices, and apparatuses that enable efficient virtualization of PIM resources, allowing each SoC client to interact with what appears to be its own dedicated PIM unit while maintaining operational integrity through translation layer management. Aspects of devices described below may address some or all of these shortcomings as well as others known in the art. Aspects of the improved devices described herein may present other benefits than, and be used in other applications than, those described above.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, memory devices, and processes to provide a thorough understanding of the present disclosure. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a processing-in-memory device.

Process-in-memory (PIM) architectures have emerged as a solution for handling computational workloads in modern computing systems including, e.g., artificial intelligence systems that require intensive matrix operations. The present disclosure describes techniques for virtualizing PIM operations across multiple system-on-chip (SoC) clients through a translation layer and its various implementations.

According to an aspect, the described architecture introduces a virtualization approach that provides each SoC client with what appears to be its own dedicated PIM unit while efficiently managing a single physical PIM resource in the memory device. Virtualization can be accomplished through a translation layer that creates an abstraction between the physical PIM hardware and the multiple clients attempting to access it—effectively eliminating resource conflicts and functional errors that often arise in multi-client scenarios.

The translation layer, which can be implemented within the memory controller, establishes and manages virtual PIM interfaces for different SoC clients including, e.g., CPUs, GPUs, and neural processing units. The SoC clients can transmit various PIM operation requests including, e.g., basic vector operations, complex multiply-accumulate functions, matrix-vector multiplications, and so on. Some aspects can incorporate an advanced context management system that maintains operational continuity by dynamically storing and re-storing execution states when switching between clients. This preserves temporary accumulator results and register states through transitions, thereby maintaining computational states even as physical resources are shared among multiple clients—each operating on different tasks.

Beyond resource sharing, aspects of this disclosure can implement mechanisms to optimize system performance and resource utilization. In some instances, the translation layer supports granular interleaving of operations from multiple clients. In doing so, it can combine compatible requests to maximize throughput and maintain correct operational functionality. Also, a priority-based arbitration system can manage access to the physical PIM unit to ensure fair resource allocation while maintaining system responsiveness under varying workload conditions.

Particular implementations of the subject matter described in this disclosure may be implemented to realize one or more of the following potential advantages or benefits. In some aspects, the present disclosure provides techniques for improving the efficiency of PIM resource utilization in heterogeneous computing environments. Virtualizing PIM operations through a translation layer eliminates functional errors and resource conflicts that often plague direct hardware context sharing among multiple clients. A foundation for executing complex computational workloads is provided as a result of virtualization through the translation layer.

That is, the translation layer’s ability to interleave operations from different clients is an advancement over traditional time-sliced approaches and substantially reduces idle time in the PIM unit while maximizing computational throughput. The interleaving, combined with operation combining capabilities, enables aspects of the concepts described herein to achieve a level of resource utilization that approaches theoretical maximums while maintaining operational correctness. And here, implementing virtual PIM interfaces creates a meaningful separation between software development and hardware implementation details. This enables parallel development tracks that reduce time-to-market for new features and capabilities.

Aspects of the disclosure provide context management capability that enables seamless transitions between client operations while preserving computational states. Such aspects may be configured to eliminate overhead and complexity often associated with context switching in traditional implementations. The state management components described herein, when coupled with priority-based arbitration mechanisms, can ensure that time-sensitive operations receive appropriate prioritization while maintaining fair access to PIM resources across all clients. Additionally, aspects of the virtual interfaces described herein can be configured to abstract away hardware implementation details, thereby enabling software development to proceed independently of underlying PIM architecture changes. Such abstractions may be configured to substantially reduce development complexity and enhance system stability.

Aspects of the virtualization approach described herein provide particular value in scaling scenarios, as the disclosed architectures can be configured to accommodate additional SoC clients without requiring modifications to the physical PIM implementation. The flexibility provided by such aspects makes the architectures suitable for evolving mobile computing platforms where, e.g., heterogeneous AI workloads continue to grow in complexity and scope. The disclosed combination of efficient resource utilization mechanisms, context management capabilities, and hardware abstraction techniques provide a foundation for expansion while maintaining compatibility with existing software implementations.

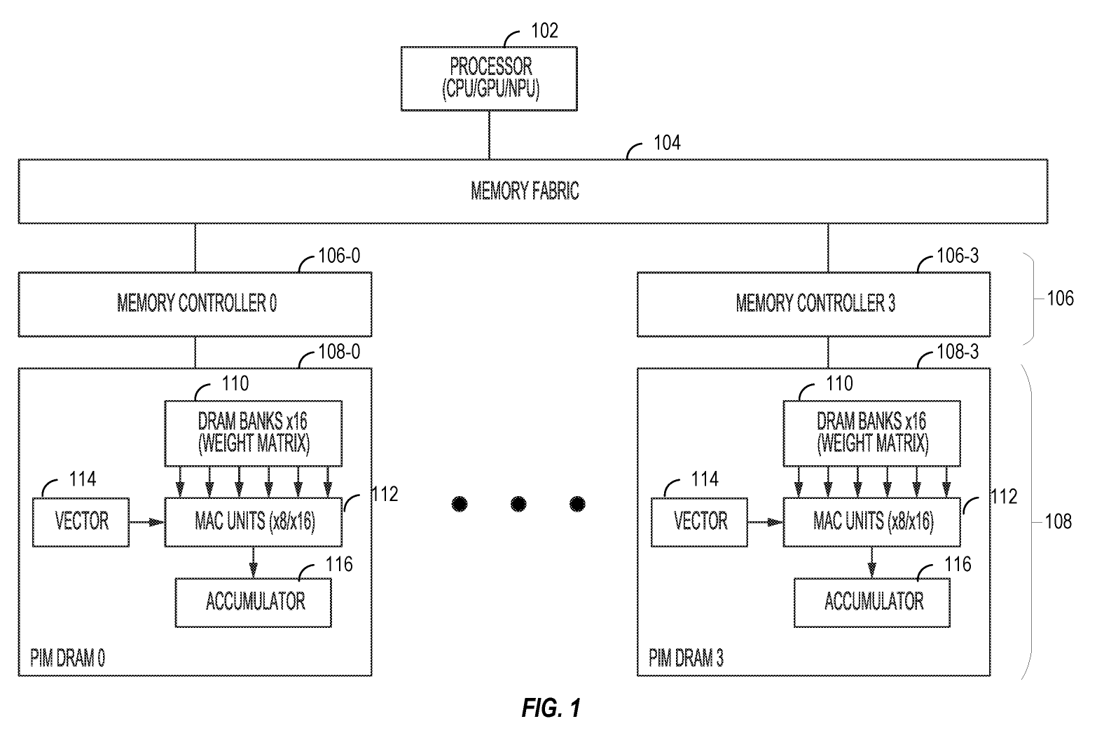

FIG. 1 is a block diagram of a process-in-memory system that can be configured for virtualizing PIM operations across multiple SoC clients through translation layer implementations according to aspects described herein. System 100 include one or more processors or processor cores 102 associated with the multiple SoC clients. The one or more processors 102 may be used in machine learning (ML), AI, and/or other computationally intensive applications, and may be implemented using various processing architectures. For example, the one or more processors 102 may include but are not limited to a central processing unit (CPU), graphics processing unit (GPU), neural processing unit (NPU), application-specific integrated circuit (ASIC), or combinations thereof. The one or more processor 102 can be configured to manage high-level operations, distribute computational tasks (e.g., further among other processors and/or SoC clients), and coordinate processing across memory devices.

A memory fabric 104 couples to the one or more processors 102 and enables data movement and processing capabilities. Memory fabric 104 can be specialized to support various processing-in-memory operations through command handling, routing protocols, and synchronization mechanisms. Memory fabric 104 may implement different interconnect technologies and topologies depending on system requirements, including point-to-point connections, crossbar switches, or mesh networks.

Memory fabric 104 connects to one or more multiple memory controllers 106 (illustrated as memory controllers 106-0 through 106-3 in one implementation, though other quantities may be implemented). Each memory controller 106 can be configured to support processing-in-memory commands and operations beyond traditional memory access patterns. Further, each memory controller 106 may perform operations on the memory 108 and may interface with the one or more processors 102 corresponding to one or more SoC clients (e.g., compute subsystems). Memory controllers 106 may implement specialized command queues, reordering logic, and timing control to manage both conventional memory operations and processing-in-memory functions. Further, each memory controller 106 may implement context loading and context restoring operations into the memory 108, for contexts associated with various tasks performed by the one or more processors 102. Different implementations may employ varying numbers of controllers based on factors such as system size, bandwidth requirements, and power constraints.

The memory fabric 104 supports the communication infrastructure between the SoC clients’ virtual PIM interfaces and the translation layers in memory controllers 106. Each SoC client (e.g., CPU, GPU, NSP) interacts with what appears to be its own dedicated virtual PIM through these communication pathways. The memory fabric 104 facilitates the transmission of PIM operation requests from these virtual interfaces to the translation layers, which then map these requests to operations on the physical PIM hardware in memory devices 108.

The illustrated virtual PIM interface architecture provides two interface layers. At the SoC client level, a generic interface remains stable across multiple generations and operates independently of the underlying PIM device architecture and implementation. This abstraction layer ensures software compatibility. At the physical layer, a unique interface accommodates varying DRAM PIM devices from multiple vendors, thereby allowing the translation layer to adapt to different hardware implementations while maintaining consistent virtual interfaces for the SoC clients.

Each memory controller 106 couples to a corresponding memory 108 in the PIM device. As shown in FIG. 1, an example of such memory 108 may be a processing-in-memory DRAM (PIM DRAM) device, and the PIM DRAM is being shown and referenced for ease of explanation. However, though other memory devices for PIM are also contemplated (e.g., PIM SRAM) and can be substituted for PIM DRAM where applicable. While four PIM DRAM devices (108-0 through 108-3) for the memory are shown, systems may scale from single devices to large arrays of devices. Each PIM DRAM 108 includes multiple DRAM banks 110, which may be implemented in various configurations (for example, eight, sixteen, or thirty-two banks per device). The DRAM banks 110 can be configured to store different types of data, such as but not limited to weight matrices for neural network computations, activation values, or general computational data structures. DRAM banks 110 may be organized into different zones or regions optimized for specific access patterns or computational requirements.

Within each PIM DRAM 108, multiply-accumulate (MAC) units 112 couple to DRAM banks 110 and can be configured to perform various computational operations, e.g., from basic multiplication and accumulation to more complex functions. The number and capability of MAC units 112 may vary by implementation, with configurations ranging from four to thirty-two units being common examples. MAC units 112 can support multiple precision formats (for example, 4-bit, 8-bit, 16-bit operations) and various operational modes, including Single Instruction Multiple Data (SIMD) execution where a single command triggers parallel execution across all units within a device.

Vector interfaces 114 (also referred to herein as “vectors” or “vector registers”) provide input paths for vector data into MAC units 112. These interfaces can support different data widths and formats, enabling flexible handling of input vectors. Vector accumulators 116 (also referred to herein as “accumulators” or accumulator registers”) couple to MAC units 112 in each PIM DRAM 108 and can be configured with varying bit widths and accumulation depths based on application requirements.

The system supports execution models across different hierarchical levels. Within each PIM DRAM 108, SIMD execution enables efficient parallel processing across MAC units. Across different PIM DRAM devices 108, Multiple Instruction Multiple Data (MIMD) execution allows independent operations to proceed in parallel, which are managed through software orchestration via spawn and synchronization mechanisms controlled by ML processor 102.

Memory controllers 106 implement complex coordination mechanisms to manage both traditional memory access as well as processing-in-memory operations. This can include specialized command scheduling, resource allocation, and synchronization across multiple devices. The architecture enables significant bandwidth improvements compared to traditional approaches by minimizing data movement between memory and processing units. In operation, system 100 can handle heterogeneous and/or diverse computational workloads by distributing operations among multiple SoC clients (via their respective processors and/or processor cores 102), and, in some embodiments, among multiple PIM DRAM devices 108. Further, the system 100 can support the multiple contexts associated with multiple workloads distributed among the multiple SoC clients by having the memory controller 106 facilitate and/or interface with virtual PIMs hosted by respective SoC clients. Even further, the system 100 can efficiently and effectively interleave the multiple workloads performed by the multiple SoC clients by having the memory controller 106 efficiently load contexts associated with these workloads into the PIM DRAM devices 108, and restore contexts from the PIM DRAM device to the virtual PIMs as needed. Data structures may be partitioned and distributed across DRAM banks 110 in various ways depending on application requirements. The architecture supports different scaling approaches, from small embedded systems to large computational arrays, while maintaining the benefit of performing computations close to data storage.

According to certain aspects, the memory controllers 106 incorporate translation layers that enable virtualization of PIM operations across the SoC clients 102. Each translation layer provides an abstraction between the physical PIM hardware in memory devices 108 and the virtual PIM interfaces used by the SoC clients. These translation layers manage context switching, operation interleaving, and coordinate access to physical PIM resources while maintaining isolation between different clients’ operation

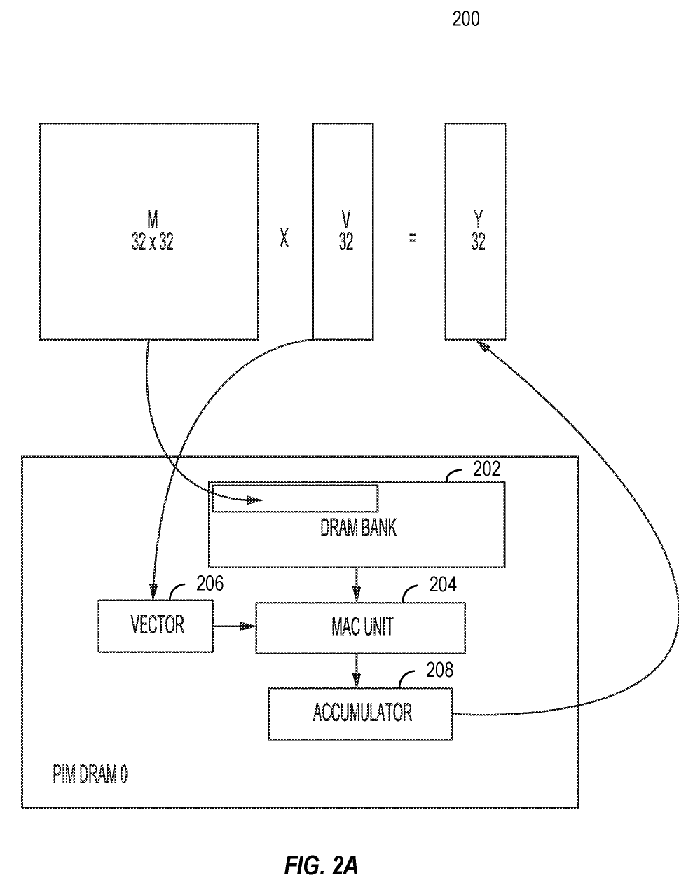

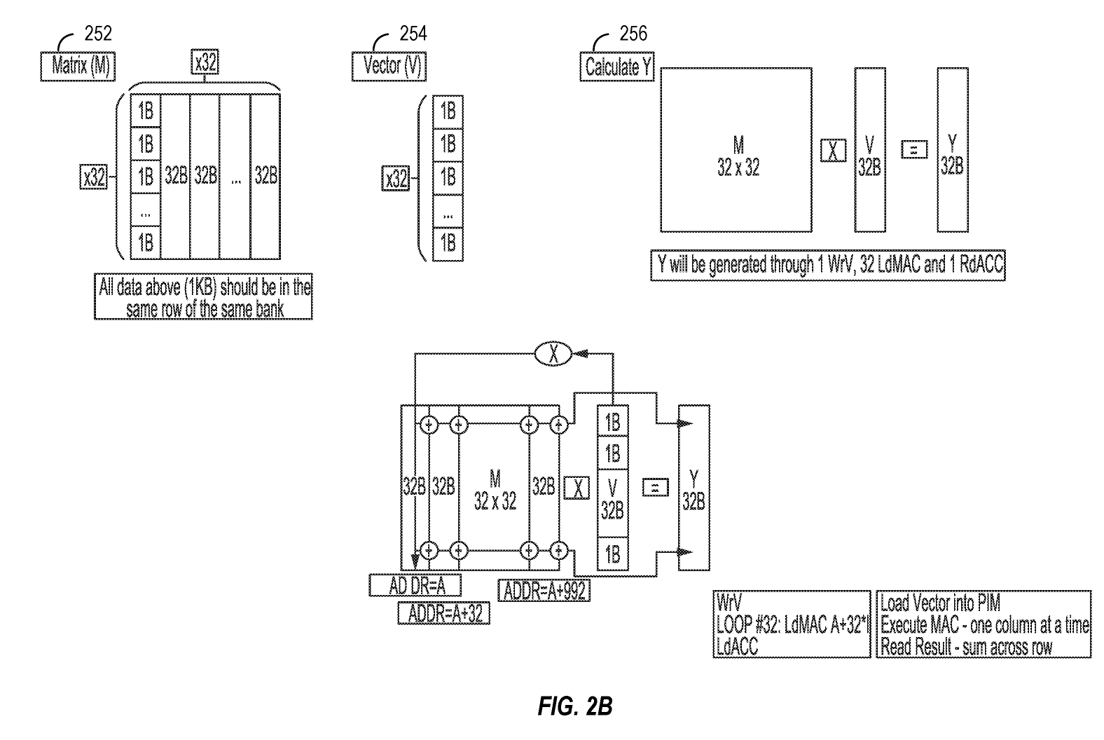

FIGS. 2A and 2B illustrate process-in-memory operation fundamentals that can support efficient matrix computations, including virtualization of PIM operations and translation layer management across multiple SoC clients, according to aspects described herein. FIG. 2A shows a basic PIM DRAM architecture 200 while FIG. 2B illustrates the corresponding operational flow 250 of matrix-vector multiplication within the architecture.

Referring to FIG. 2A, a PIM DRAM architecture 200 can include a DRAM bank 202 configurable to store matrix data, such as neural network weight matrices. In mobile or resource-constrained systems, these weights may be stored in reduced precision formats, such as 4-bit values, to minimize memory footprint. A MAC unit 204 can couple to DRAM bank 202 and may process matrix values along with vector inputs. Vector register 206 can provide storage for input vectors and may couple to MAC unit 204. An accumulator 208 can couple to MAC unit 204 and may store operation results.

FIG. 2B details the operational flow 250 of matrix-vector multiplication within architecture 200. A weight matrix M 252 can be arranged as a 32 x 32 matrix occupying, for example, 1 kilobyte of memory in DRAM bank 202, though other sizes and arrangements may be implemented. An input vector V 254 may comprise 32 elements stored in vector register 206, with the size being configurable based on implementation requirements. The multiplication operation produces a result vector Y 256 that can be stored in accumulator 208.

The operational sequence can begin with a Write Vector (WrV) operation that loads input data into vector register 206. After activating the appropriate DRAM page, the system can perform a series of Load and MAC (LdMAC) operations, processing one matrix column at a time through MAC unit 204. Results may accumulate in accumulator 208 and can be accessed through Load Accumulator (LdACC) operations.

Implementation of the PIM architecture 200, as shown in FIG. 2A and 2B, illustrates the fundamental components and operational flow of PIM virtualization. A translation layer, which resides within one or more of the memory controllers 106 shown in FIG. 1, enables virtualization of PIM operations across multiple SoC clients performing, e.g., heterogeneous AI/ML workloads. Each SoC client interacts with its own dedicated virtual PIM interface, e.g., a virtual CPU PIM for the CPU, a virtual GPU PIM for the GPU, and a virtual NSP PIM for the NSP. Thes virtual interfaces communicate with the translation layer, which in turn manages access to the physical DRAM PIM containing DRAM bank 202, vector register 206, MAC unit 204, and accumulator register 208.

The illustrated architecture establishes a separation between the virtual PIM interfaces presented to SoC clients and the physical PIM resources they ultimately utilize. When an SoC client transmits operations through its virtual PIM interface, the translation layer in the memory controller 106 coordinates how these operations map to the physical DRAM PIM components. This coordination encompasses managing context switches between clients, where the translation layer preserves the current operational state by saving register contents and accumulator values before transitioning between different clients’ operations. For example, when switching between clients, the translation layer can temporarily store context information in DRAM bank 202, thereby enabling seamless restoration of computational states when operations resume.

The translation layer enables granular interleaving of operations from different clients while maintaining isolation between their respective contexts. This virtualization approach allows each SoC client to interact with what appears to be its own dedicated PIM resources, while the translation layer efficiently manages the underlying physical components across all active clients. The architecture effectively decouples the client-facing virtual PIM interfaces from the actual physical PIM implementation to provide a consistent interface that can accommodate various PIM hardware implementations from different vendors.

The foregoing and other implementations can build upon the architecture and operational flow illustrated in FIGS. 2A and 2B, with various implementations possible depending on system requirements and constraints.

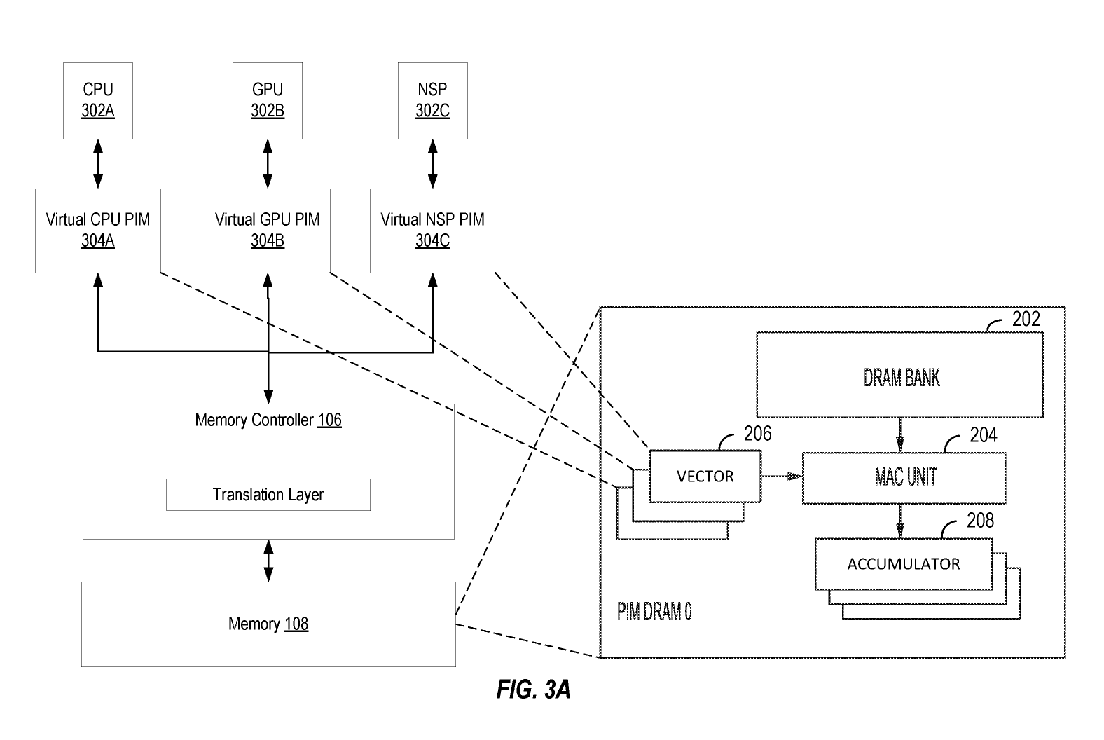

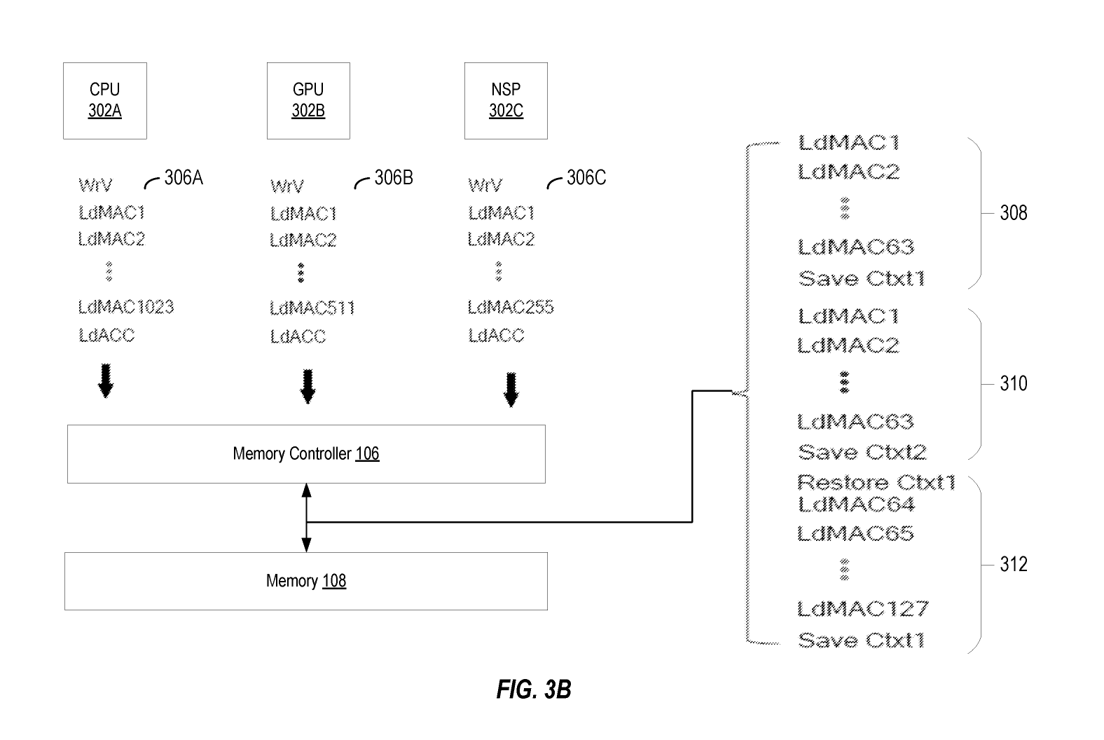

FIG. 3A shows an operational flow diagram illustrating how a translation layer operating at or in combination with a memory controller, e.g., memory controller 106, can be configured to enable virtualization of PIM operations across multiple SoC clients according to one or more aspects of this disclosure. As previously discussed, modern mobile computing systems can be configured to support heterogeneous AI architectures, where computational tasks may be distributed over multiple compute subsystems within a system-on-chip (SoC). For example, as shown in FIG. 3A, such SoC clients can include but need not be limited to a CPU 302A, a GPU 302B, and an NSP 302C. Since PIM units in DRAMs can be configured to support a single hardware context to minimize area overhead, virtualization techniques may be implemented to enable efficient sharing of PIM resources while preventing functional errors that could arise from direct hardware sharing. The translation layer can be configured to provide abstraction capabilities that enable multiple SoC clients to efficiently share PIM resources while maintaining operational isolation.

The present disclosure describes various embodiments for virtualizing PIM operations through a translation layer that can be implemented in the memory controller 106. This translation layer can be configured to create an abstraction between physical PIM hardware and multiple SoC clients through virtualization techniques. As shown in FIG. 3A, each SoC client can be configured to interact with its own dedicated virtual PIM interface—a virtual CPU PIM 304A, a virtual GPU PIM 304B, and a virtual NSP PIM 304C for the CPU 302A, GPU 302B, and NSP 302C, respectively. Each virtual PIM can be configured to present a generic interface that may remain stable across multiple generations and can operate independently of the underlying PIM device architecture and implementation. The memory controller 106 can be configured to facilitate the generation of these virtual PIM interfaces for each SoC client. Further, through the translation layer, each virtual PIM interface presents its associated SoC client with an environment where tasks can be performed as if the physical PIM resources were dedicated to that client. By enabling SoC clients to perform tasks through their respective virtual PIM interfaces, the limited physical PIM resources can be made more accessible and efficiently shared across multiple clients.

In some implementations, the physical PIM resources can be configured, modified, and optimized to support multiple virtual contexts through the translation layer. In at least one implementation, this optimization may involve management of register resources. For example, as shown in FIG. 3A, the memory 108, which can be implemented as a PIM DRAM, may comprise the DRAM bank 202, one or more vector registers 206, one or more MAC units 204, and one or more accumulator registers 208—components described previously in relation to FIGS. 1-2B. The translation layer can be configured to coordinate how virtual operations from each SoC client map to these physical components while maintaining proper isolation. Through the translation layer, this includes managing states of the vector register 206 and accumulator register 208 for each client’s operations through the MAC unit 204, ensuring computational integrity across context switches.

The translation layer residing in memory controller 106, can be configured to implement a unique interface for communicating with the physical DRAM PIM that may adapt to different vendor implementations. When an SoC client submits operations through its virtual PIM interface, the translation layer can be configured to manage context switching between clients. Management can include storing current context information such as register states and accumulator values in DRAM bank 202. The translation layer within memory controller 106 processes and stores contexts, managing these context values to control the physical PIM resources. For example, the memory controller 106 can be configured to save contexts to physical registers when available or to a separate storage device such as DRAM bank 202 that may serve as a context bank.

The illustrated virtualization architecture can be configured to enable efficient PIM resource sharing even with limited physical hardware contexts. When the translation layer manages context information for one client, it can be configured to store complete state information in DRAM bank 202, enabling other clients’ operations to utilize the physical resources. When client operations resume, the translation layer can be configured to retrieve stored contexts and restore appropriate states to the physical registers and units. Through this configurable context management and hardware abstraction, the illustrated architecture can support multiple virtual PIM interfaces while maintaining consistent performance and operational integrity across all clients. The memory controller 106 can be configured to retrieve values associated with contexts from separate storage and reload those values to physical registers as needed, enabling seamless context switching between multiple clients even with limited physical resources.

FIG. 3B shows an operational flow diagram illustrating how a translation layer can be configured to efficiently manage context switching between multiple virtual PIM interfaces according to one or more aspects of this disclosure. When running multiple contexts through virtual interfaces within the PIM architecture, operational conflicts can lead to functional errors without proper management. For example, if multiple contexts include a first context associated with operations through a first virtual PIM interface, and a second context from a second virtual PIM interface, switching between them requires careful coordination. A first virtual PIM interface may begin writing vector values to a vector register and then initiate loading vector values to a MAC unit (e.g., for each column of a matrix). However, before these loaded values can be stored in an accumulator register, a second virtual PIM interface might begin writing new vector values to the vector register. This could result in the MAC unit performing incorrect calculations for the first virtual interface’s operations because previously entered values have been overwritten by the second virtual interface. This lack of synchronized access through virtual interfaces can lead to erroneous computations for context storage and, consequently, functional errors in the application. Further, completely serializing operations through each virtual interface by requiring full task completion before switching would significantly impact application performance and degrade user experience and quality of service. As such, FIG. 3B demonstrates how the translation layer can be configured to efficiently manage context switches while maintaining operational integrity across virtual interfaces.

As shown in FIG. 3B, multiple SoC clients (e.g., CPU 302A, GPU 302B, and NSP 302C) can be configured to interact with their respective virtual PIM interfaces when executing tasks within a heterogeneous computing framework. Each virtual interface handles a specific command sequence (e.g., commands 306A assigned to CPU 302A’s interface, commands 306B assigned to GPU 302B’s interface, and commands 306C assigned to NSP 302C’s interface). The translation layer in memory controller 106 can be configured to map these virtual operations to physical resources, coordinating how context information from each virtual interface is managed in memory 108 (e.g., in physical registers and/or DRAM bank 202).

“The translation layer can be configured to manage interleaved execution of operations from multiple virtual interfaces as shown in FIG. 3B. For example, when CPU 302A initiates execution through its virtual interface, it begins by writing values into a vector register (“WrV”). These values are then processed through one or more MAC units 204 in a repetitive sequence based on the number of matrix columns. This loading process, shown via the LdMAC command sequence in FIG. 3B, encompasses operations from LdMAC1 through LdMAC1023. However, as illustrated in section 308, the translation layer’s context switching protocol interrupts the CPU 302A’s virtual interface operations after executing LdMAC63. The translation layer initiates context preservation through the Save Ctxt1 command. In response, the translation layer stores the current operational state and progress information for task 306A in memory 108, either in physical registers or dedicated storage areas such as DRAM bank 202.

The translation layer’s context switching protocols can be configured based on multiple operational factors and system requirements. Virtual interfaces and their associated operations may be assigned different priority levels depending on application characteristics or device requirements. For example, the translation layer may be configured to detect high-priority operation requests through a virtual interface and initiate immediate context switching to accommodate these priority operations. Additionally, operations executing through virtual interfaces may be subject to predetermined execution time limits or data volume thresholds to prevent any single virtual interface from monopolizing physical PIM resources. These constraints help ensure balanced resource allocation across all virtual interfaces while maintaining system responsiveness.

Following switching protocols, the translation layer coordinates transitions between virtual interfaces. As shown in FIG. 3B, after preserving CPU 302A’s context, the translation layer initiates execution of GPU 302B’s operations (task 306B). This includes directing the initial vector register write (WrV) followed by a series of MAC unit operations spanning LdMAC1 through LdMAC511. The translation layer proceeds through LdMAC63 before determining that another context switch is needed. The translation layer then initiates context preservation through the Save Ctxt2 command. The translation layer manages this preservation process, storing all relevant operational state information, including any accumulated values, register contents, and computational progress. This state preservation can include storing values in both dedicated accumulator registers and the context storage area within DRAM bank 202, ensuring that no computational state is lost during virtual interface transition.

When resuming previously suspended operations, the translation layer manages the entire context restoration process (initiated via the Restore Ctxt1 command), enabling seamless continuation through the appropriate virtual interface. This restoration process encompasses retrieving all stored context information from memory 108, including both register states and computational progress data. The translation layer can manage the reloading of this context information to the physical PIM resources to ensure that register values, accumulator states, and other operational parameters are restored to their respective previous states. In some implementations, the translation layer may need to coordinate with the virtual interface to ensure proper resumption of operations, potentially including validation of restored state information. Through this context management the translation layer maintains the illusion of dedicated PIM resources for each virtual interface while efficiently sharing underlying physical hardware. Such virtualization enables concurrent task execution with proper isolation to maximize resource utilization while maintaining computational integrity across all virtual interfaces.

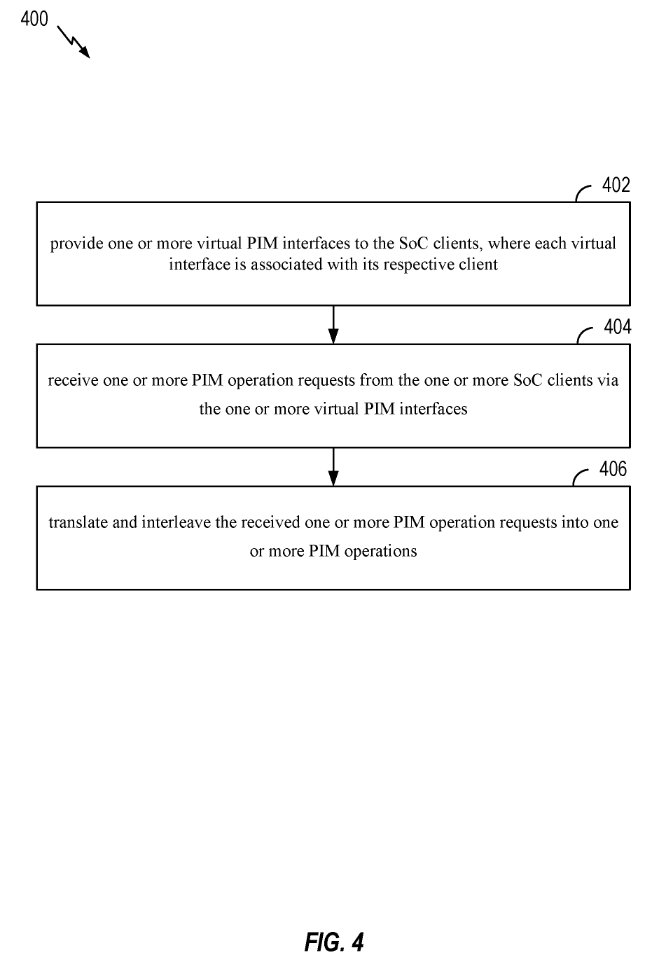

FIG. 4 shows a flow chart of an example process 400 performable by or at an apparatus and/or a memory controller for virtualizing Process In Memory (PIM) operations according to aspects described herein. For example, a translation layer in one or more memory controllers can implement process 400 through various components working together to provide virtualized PIM capabilities across multiple SoC clients while maintaining operational efficiency. In some implementations, process 400 may be performed by a translation layer residing in memory controller 106 of memory device 108. The translation layer can be configured to perform the operations described below based on executable instructions stored in memory.

At block 402, an apparatus (e.g., apparatus 100 and/or memory controller 106 comprising a translation layer) provides one or more virtual PIM interfaces to the SoC clients, where each virtual interface is associated with its respective client. The virtual PIM interfaces provided at block 402 enable virtualized access to PIM resources as part of a heterogeneous computing architecture involving various compute subsystems performing different aspects of application tasks. For example, in some implementations, the apparatus may establish multiple virtual PIM interfaces prior to receiving any operation requests, configuring each interface according to its associated SoC client’s requirements. The apparatus may further configure how each virtual interface maps to the physical PIM resources, establishing the translation parameters needed for virtualizing operations. In some implementations, as the apparatus establishes each virtual interface (e.g., through configuration parameters and mapping definitions received via a communication network from an external device or server), it may initialize context storage capabilities for that interface. For example, the apparatus may allocate memory space in DRAM bank 202 for storing context information associated with operations through each virtual interface, enabling efficient context switching during operation. The apparatus can configure these virtual interfaces to accommodate different PIM architectures while maintaining consistent interface definitions for the SoC clients, thereby allowing architectural flexibility without impacting client operations.

At block 404, the apparatus (e.g., apparatus 100 and/or memory controller 106 comprising the translation layer) receives PIM operation requests from the SoC clients through their associated virtual PIM interfaces. The operation requests can encompass a variety of PIM operations, such as requests to write data to vector registers in the PIM unit, perform multiply-accumulate operations using stored data, read from accumulator registers, execute matrix-vector multiplications, conduct element-wise vector operations, or perform reduction operations on data stored in the PIM unit. The apparatus may manage the requests through arbitration—granting access to the PIM unit to each SoC client for designated time periods. For example, the apparatus may assign priorities to requests from different SoC clients to ensure efficient resource utilization. The arbitration process can consider various operational factors, including but not limited to: execution time thresholds for specific operations, data volume requirements, and relative priorities of different SoC clients or their requested operations. If an operation exceeds thresholds for execution time or data volume, the apparatus may initiate context switching to maintain system responsiveness. Additionally, the apparatus may implement priority-based arbitration where high-priority requests from certain SoC clients can trigger immediate context switches, ensuring critical operations receive necessary resources while maintaining overall system efficiency.

At block 406, the apparatus (e.g., apparatus 100 and/or memory controller 106 comprising the translation layer) translates the received PIM operation requests into physical PIM operations, and interleaves the physical PIM operations. Translating the received requests can involve mapping virtual interface requests to the physical PIM unit while maintaining operational isolation between different SoC clients. For example, the apparatus may store context information for each SoC client, including temporary accumulator results and register states associated with incomplete operations in memory bank 202. When a context switch occurs between different SoC clients’ requests, the apparatus stores the current context information for one client while retrieving and restoring previous context information for another client, ensuring operational continuity. The translation layer maps operations from virtual interfaces to physical components such as vector registers, MAC units, and accumulator registers in the PIM unit. In some implementations, the apparatus may optimize resource utilization by combining compatible operation requests from multiple SoC clients into unified operations that can be translated into single instruction sets for the PIM unit. For example, when multiple SoC clients request similar matrix-vector operations, the apparatus may combine these into a consolidated operation sequence. Through this translation and interleaving process, the apparatus maintains the appearance of dedicated PIM resources for each virtual interface while efficiently managing the shared physical hardware.

In some implementations of the translation and interleaving process, the apparatus may employ different strategies for managing virtual-to-physical resource mapping. For example, in configurations where each SoC client is allocated specific physical registers in the PIM device, the translation layer maps operations from each virtual interface to its designated physical resources, such as specific accumulator registers or MAC units. This dedicated resource allocation can streamline the translation process while maintaining isolation between different clients’ operations.

The apparatus may manage operation sequencing and context switches with granularity. For instance, when translating operations from one virtual interface (e.g., CPU 302A’s virtual interface) to another (e.g., GPU 302B’s virtual interface), the translation layer can preserve partial execution states. This might occur when MAC operations are partially complete, requiring the apparatus to store intermediate results before switching contexts. The translation process supports fluid transitions between operations from different virtual interfaces, with the ability to resume previously suspended operations by restoring their preserved context information.

The translation layer’s context management functionality can extend to complex operational sequences across multiple virtual interfaces. When restoring previously suspended operations, the apparatus can retrieve the stored context information—including register states, accumulator values, and operation progress markers—and reconstruct the operational state through the appropriate virtual interface. The reconstruction ensures that operations can resume where they left off to maintain computational integrity while enabling efficient resource sharing across virtual interfaces.

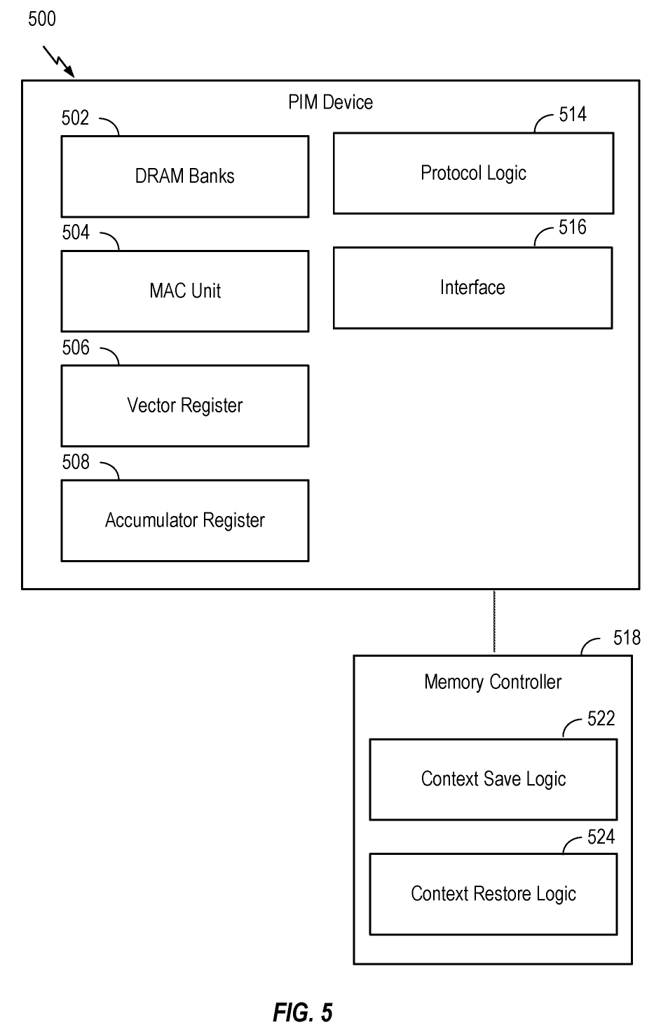

FIG. 5 illustrates a block diagram of an apparatus 500 configured to virtualize Process-In-Memory (PIM) operations according to one or more aspects of this disclosure. For example, apparatus 500 can be configured to provide virtual PIM interfaces to multiple SoC clients while managing translation between virtual and physical PIM operations through a translation layer that maintains operational isolation between clients. The apparatus can be configured to perform process 400 and related virtualization techniques described herein.

Apparatus 500 includes one or more DRAM banks 502 (such as DRAM bank 202) configured to store both operational data and context information for multiple virtual interfaces. Each DRAM bank 502 can be configured to couple to a MAC unit 504 through a dedicated data bus that enables both direct matrix-vector operations and context data transfers. The data bus architecture can be configured to support simultaneous context preservation operations alongside computational tasks. Each MAC unit 504 can be configured to perform matrix-vector multiplication operations while supporting state preservation for context switching between virtual interfaces. When implemented to support different operation types, MAC units 504 can include circuitry configured to process data of varying bit-widths—for example, weight values of 4 bits alongside vector values of 8 bits.

The apparatus includes vector registers 506 that can be configured to store input vectors during processing while simultaneously supporting rapid context switching capabilities. Vector registers 506 can be configured to handle varying data formats and bit-widths to accommodate different operation types across virtual interfaces. In some implementations, vector registers 506 can maintain separate storage areas for each virtual interface’s active operations to enable rapid transitions between contexts without data movement. The registers can also be configured to support parallel access patterns that allow simultaneous context preservation and new data loading.

Accumulator registers 508 can be configured to maintain operational states and context information for multiple virtual interfaces. Through connections to MAC units 504, accumulator registers 508 can preserve partial results during matrix-vector operations while supporting immediate context switches. The registers 508 can maintain operation progress markers alongside accumulated values and, in some implementations, they can be partitioned to support multiple concurrent virtual interfaces. The accumulator registers 508 can also be configured to implement verification mechanisms that ensure data integrity during context switches.

Memory controller 518 coordinates virtualization operations through a translation layer. The controller includes context save logic 522 that can be configured to preserve complete operational states when switching between virtual interfaces. For example, when transitioning between SoC clients’ virtual interfaces, context save logic 522 can capture and preserve register contents, accumulator values, operation progress markers, and other state information critical for maintaining operational continuity. The controller may interface with virtual PIM interfaces to determine values stored in various virtual registers and map them to physical storage locations, either in dedicated registers or DRAM banks 502. Context restore logic 524 complements the foregoing capabilities by managing state restoration procedures when resuming operations through different virtual interfaces.

The apparatus 500 implements context switching through the translation layer in memory controller 518, which manages transitions between virtual interfaces based on multiple operational factors. The translation layer’s context switching functionality can be implemented through protocol logic 514, which provides additional hardware support for managing transitions. For example, the apparatus 500 can monitor execution time thresholds for specific operations, track data volume metrics across virtual interfaces, and maintain priority hierarchies among SoC clients. When the apparatus 500 receives high-priority operation requests through one virtual interface, the translation layer can trigger immediate context preservation for current operations before transitioning resources to the high-priority client. In some implementations, the apparatus 500 can be configured to receive switching commands from external sources (e.g., through interface unit 516) or generate them internally based on monitored operational metrics. The apparatus 500 maintains dedicated storage in DRAM banks 502 for preserving switching states and transition histories.

Interface unit 516 provides communication capabilities between the apparatus and SoC clients, managing both virtual interface presentations and physical data transfers. The unit 516 can be configured to support remote SoC client connections while maintaining consistent virtual interface presentations regardless of client location. For matrix-vector operations, the interface unit 516 coordinates data movement between clients and physical resources while preserving the virtualization abstraction. Also, the interface unit 516 can execute handshaking protocols that maintain operational integrity during context switches and ensure proper synchronization between virtual and physical resources.

In operation, apparatus 500 executes process 400 by coordinating actions across its components to maintain virtual PIM interfaces while managing physical resources. Memory controller 518, through its translation layer, manages all context switching operations and can initiate operations through any virtual interface by configuring appropriate register states and establishing initial context parameters. When the translation layer determines that operations through one virtual interface should be interrupted, context save logic 522 captures complete operational state—including partial results from MAC units 504, current vector register 506 contents, and accumulator register 508 values. This state information can be preserved either in dedicated physical registers assigned to specific clients or in designated areas of DRAM banks 502. Context restore logic 524 manages the reverse process when resuming interrupted operations, ensuring precise state reconstruction before operation restart. Throughout these transitions, the apparatus maintains strict isolation between different virtual interfaces while optimizing physical resource utilization.

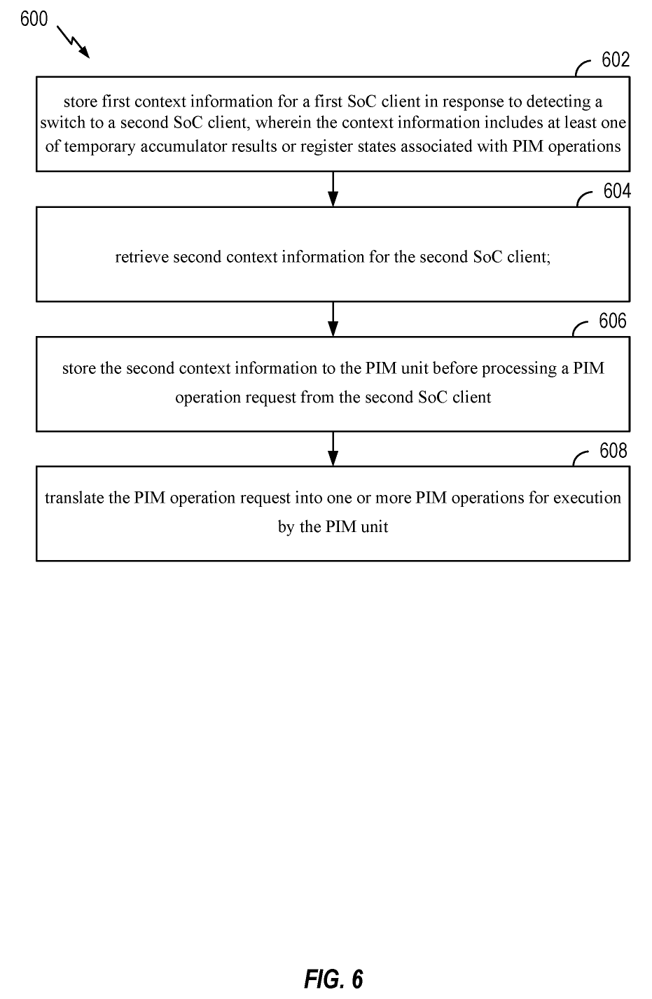

FIG. 6 shows a flow chart of an example process 600 performable by or at an apparatus and/or a memory controller for virtualizing Process In Memory (PIM) operations through context-aware translation layer management according to one or more aspects of this disclosure. An apparatus and/or memory controller can implement process 600 through various hardware and software components working together to manage context switching and translation between virtual and physical PIM operations while maintaining computational efficiency and operational isolation between SoC clients. For example, process 600 may be performed by an apparatus comprising a system-on-chip (SoC) with one or more SoC clients and a memory device with a PIM unit where the SoC communicates with the memory device through a memory controller containing a translation layer. In some embodiments, the apparatus may be configured to perform one or more of the following blocks based on executable instructions stored in memory (e.g., memory 108).

An apparatus implementing process 600 can enable virtualization of PIM operations in architectures supporting heterogeneous computing workloads, such as AI applications that leverage multiple processing elements. In such heterogeneous environments, computational tasks are distributed across various SoC clients -including CPUs, GPUs, and NPUs—to optimize processing efficiency. The apparatus’ translation layer, integrated within the memory controller, enables matrix-vector operations within the memory device while presenting virtual PIM interfaces to SoC clients. Doing so combines the benefits of heterogeneous computing with PIM capabilities by allowing each SoC client to interact with what appears to be its own dedicated PIM resources. Moreover, the translation layer manages the mapping between virtual operations and physical PIM resources. Through virtualization, the apparatus can maintain isolation between different clients’ operations and maximize the utilization of physical PIM hardware components including, e.g., vector registers, MAC units, and accumulator registers.

At block 602, the process 600 stores first context information for a first SoC client when the translation layer identifies a potential transition requirement to a second SoC client’s virtual PIM interface. The context information may be configured to capture operational state data, including temporary accumulator results and register states that can be associated with in-progress PIM operations. During matrix-vector multiplication operations, for instance, the process 600 can be configured to preserve intermediate MAC unit results, vector register contents, and accumulator states that may define the interruption point. The storage implementation can be configured to utilize either dedicated physical registers that may be assigned to specific SoC clients or a structured context storage area that can be maintained within memory bank 202. The process 600 can be configured to implement different preservation strategies based on operation complexity—potentially maintaining comprehensive state data for matrix operations while implementing streamlined storage for simpler vector computations. This configurable approach to context preservation can be designed to enable operational continuity when the first client’s interface becomes active again.

At block 604, the process 600 retrieves second context information for the second SoC client to enable reconfiguration of physical PIM resources for the second client’s virtual interface operations. The retrieval mechanisms can be implemented differently based on operational states and hardware configurations. Where operations were previously suspended, the process 600 can be configured to access comprehensive stored context data encompassing register states, accumulator values, and operational markers that define precise execution points. The process 600 can be designed to support multiple retrieval paths—potentially accessing context directly from dedicated physical registers in implementations with client-specific hardware allocations, or retrieving from structured storage areas in memory bank 202 that can maintain separated contexts for each virtual PIM interface. For new operation sequences, the process 600 can be configured to implement initialization protocols that establish appropriate starting conditions through parameter retrieval and state configuration. The process 600 can incorporate verification mechanisms during retrieval to ensure context integrity before proceeding with resource reconfiguration.

At block 606, the process 600 stores the retrieved second context information to the PIM unit before any operation requests from the second client are processed. Storing the second context information can involve writing state data to multiple physical components–including vector register values, MAC unit states, and accumulator contents–according to specific timing and synchronization protocols. For matrix-vector multiplication contexts, the process 600 can be configured to store complex state arrangements that may include multiple MAC unit states and specific accumulator register patterns required for computational continuity. Here, the storing step can incorporate verification mechanisms to validate successful data transfer and state preservation. The process 600 can be configured to sequence these storage operations to maintain isolation between different virtual interfaces’ context information, potentially implementing checksums or other validation techniques to ensure data integrity during the storing process.

At block 608, the process 600 translates PIM operation requests from the second SoC client into physical PIM operations for PIM unit execution. Here, a translation layer can implement mapping strategies based on operation types and available hardware resources, while leveraging restored context information for optimization opportunities. For matrix-vector operations, the process 600 can be configured to decompose virtual interface requests into optimized sequences of physical MAC unit operations, potentially incorporating dynamic adjustments based on current hardware states and resource availability. Further, translation can be implemented to support advanced optimizations including operation combining, where compatible requests can be merged into instruction sequences, and intelligent scheduling that maximizes parallel execution capabilities. The process 600 can maintain comprehensive operation tracking that preserves execution progress data and context states needed for future transitions, while implementing isolation protocols that prevent interference between virtual interfaces. As such, translating the operation requests can enable efficient resource utilization while maintaining operations across different virtual PIM interfaces.

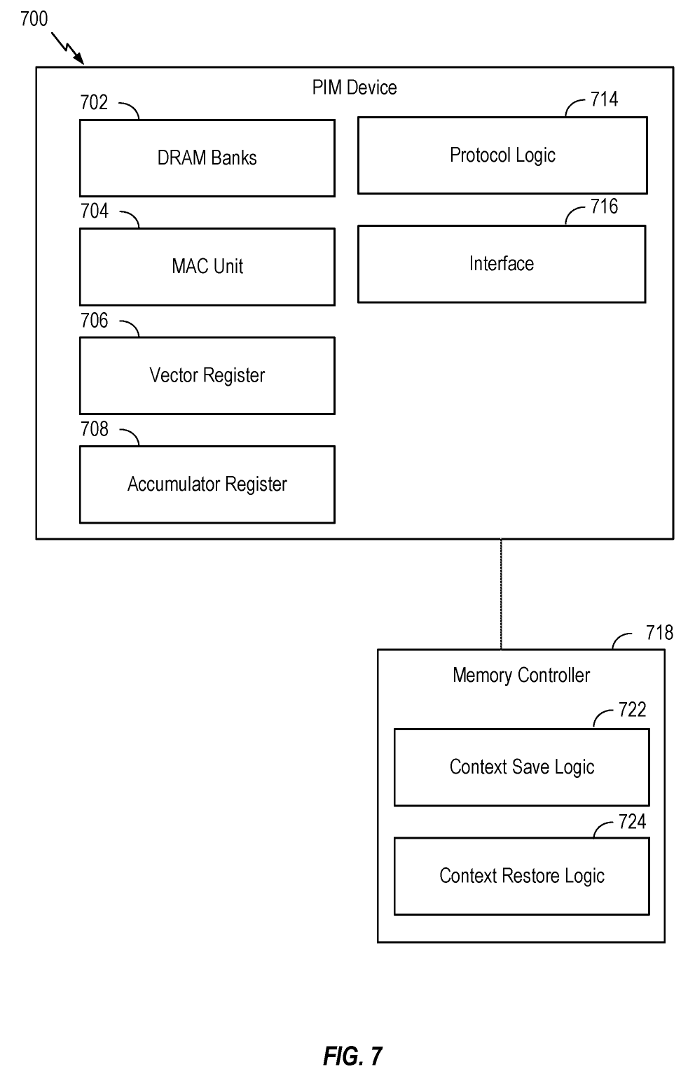

FIG. 7 illustrates a block diagram of an apparatus 700 configured to manage context switching in Process-In-Memory (PIM) operations according to one or more aspects of this disclosure. For example, apparatus 700 can be configured to store and manage context information for multiple SoC clients through a translation layer that maintains operational isolation. The apparatus 700 can be configured to perform process 600 and related context management techniques described herein.

Apparatus 700 includes one or more DRAM banks 702 configured to store operational data and context information from multiple SoC clients. Each DRAM bank 702 can be configured to couple to a MAC unit 704 through a dedicated data bus that enables both computational operations and context data transfers. The data bus architecture can be configured to support parallel context preservation and active computations. Each MAC unit 704 can be configured to perform matrix-vector multiplication operations while supporting immediate state preservation for context switches. In implementations supporting varying operation types, MAC units 704 can include circuitry configured to handle different data formats—for example, processing matrix values of one bit-width while managing context data of another.

The apparatus 700 includes vector registers 706 that can be configured to maintain both active computational states and preserved context information. Vector registers 706 can be configured to implement state preservation mechanisms that capture operational context during client switches. In some implementations, vector registers 706 can maintain dedicated storage regions for preserved contexts to ensure context switches without data corruption risks. The registers 706 can also be configured to implement verification protocols that validate context integrity during storage and retrieval operations.

Accumulator registers 708 can be configured to preserve partial operation results during context switches between SoC clients. Through dedicated paths to MAC units 704, accumulator registers 708 can maintain computation results while supporting context transitions. The registers can be configured to implement a hierarchical storage structure where active results and preserved contexts exist without interference. In some implementations, accumulator registers 708 can support multiple preserved contexts simultaneously, with hardware-enforced isolation between different clients’ state information.

Memory controller 718 is in communication with the apparatus 700 and coordinates context management operations through, e.g., different logic blocks. The controller 718 can include context save logic 722 that can be configured to capture complete operational states when switching between SoC clients. For example, when a switch is detected, context save logic 722 can preserve register contents, accumulator values, and operation markers that define the exact execution point. The controller 718 interfaces with physical resources to gather context information and manage its storage either in dedicated registers or DRAM banks 702. Further, context restore logic 724 manages the reverse process, and coordinates state reconstruction before operations resume.

The apparatus 700 implements a context switching protocol that resides in protocol logic 714, which manages transitions between SoC clients based on operational states. The apparatus 700 can be configured to monitor various switching triggers, such as execution time thresholds, operation priorities, or explicit client requests. When high-priority context switches are required, the apparatus 700 coordinates with context save logic 722 to ensure complete state preservation before transition. In some implementations, the apparatus 700 maintains a context history log in DRAM banks 702 that tracks switching patterns and helps optimize future transitions. The apparatus 700 can also be configured to implement pre-emptive context preservation for critical operations.

Interface unit 716 enables comprehensive communication between the apparatus and SoC clients while managing context preservation requirements. The interface unit 716 can be configured to handle both local and remote client connections, maintaining consistent context management capabilities regardless of client location. For matrix-vector operations, interface unit 716 coordinates computational data transfers and context preservation operations, implementing handshaking protocols that ensure operational integrity during state transitions. The interface unit 716 can also be configured to provide clients with status information about their preserved contexts.

In operation, apparatus 700 executes process 600 by coordinating context management across its components. When a switch between SoC clients is detected, memory controller 718 initiates context preservation by capturing complete operational state—including MAC unit results, vector register contents, and accumulator values. The context information can be stored in dedicated physical registers or in areas of DRAM banks 702. When operations resume for a previous client, context restore logic 724 manages reconstruction of preserved state to validate context integrity before enabling operation restart. During such transitions, the apparatus 700 maintains isolation between different clients’ contexts while optimizing physical resource utilization.

The apparatus 700 can further implement context preservation strategies depending on operation types and client requirements. For instance, for matrix-vector operations, context save logic 722 can be configured to preserve not only register states but also intermediate computation results and operation progress markers. The apparatus 700 can maintain dedicated regions within DRAM banks 702 organized as context banks, where each SoC client’s preserved states can be stored with appropriate metadata for efficient retrieval. In some implementations, the context banks can be configured with error detection and correction capabilities to ensure context integrity during long-term storage.

Memory controller 718 can be configured to implement scheduling algorithms that optimize context switching operations. For example, when multiple context switches are pending, the controller 718 can batch preservation operations to minimize overhead. The controller may also implement predictive context restoration by pre-loading context data based on historical switching patterns or from information provided in context switching protocol 714. These optimizations can be particularly important for scenarios involving frequent switches between compute-intensive operations from different SoC clients.

In one or more aspects, techniques for virtualizing process-in-memory operations may include additional aspects, such as any single aspect or any combination of aspects described below or in connection with one or more other processes described elsewhere herein. Additionally, an apparatus may perform or operate according to one or more aspects as described below. In some implementations, the apparatus includes a processing-in-memory device. In some implementations, the apparatus includes at least one processor and a memory coupled to the processor. The processor may be configured to perform operations described herein with respect to the apparatus. In some other implementations, the apparatus may include a non-transitory computer-readable medium having program code recorded thereon, the program code being executable by a computer for causing the computer to perform operations described herein. In some implementations, the apparatus may include one or more means configured to perform operations described herein.

In a first aspect, an apparatus for virtualizing Process In Memory (PIM) operations includes a system-on-chip (SoC) including one or more SoC clients, a memory controller comprising a translation layer, and a memory device comprising a process-in-memory (PIM) unit and configured for communication with the SoC via the memory controller, wherein the translation layer is configured to provide one or more virtual PIM interfaces to the one or more SoC clients, wherein the one or more virtual PIM interfaces is associated with the one or more SoC clients, receive one or more PIM operation requests from the one or more SoC clients via the one or more virtual PIM interfaces, and translate the received one or more PIM operation requests into one or more PIM operations and interleave the one or more PIM operations.

In a second aspect, in combination with the first aspect, the one or more PIM operation requests include at least one of: a request to write data to a vector register in the PIM unit, a request to perform a multiply-accumulate operation using data stored in the PIM unit, a request to read data from an accumulator register in the PIM unit, a request to perform a matrix-vector multiplication operation, a request to perform an element-wise vector operation, or a request to perform a reduction operation on data stored in the PIM unit.

In a third aspect, in combination with one or more of the first aspect through the second aspect, the translation layer is further configured to enable a consistent virtual PIM interface to the one or more SoC clients across one or more PIM hardware implementations.

In a fourth aspect, in combination with one or more of the first aspect through the third aspect, the one or more virtual PIM interfaces are configured to accommodate one or more PIM architectures.

In a fifth aspect, in combination with one or more of the first aspect through the fourth aspect, at least one of the one or more SoC clients includes a central processing unit (CPU), a graphics processing unit (GPU), or a neural processing unit (NPU).

In a sixth aspect, in combination with one or more of the first aspect through the fifth aspect, the memory controller is further configured to arbitrate one or more requests from each of the one or more SoC clients and grant access to the PIM unit to each of the one or more SoC clients for a time period.

In a seventh aspect, in combination with one or more of the first aspect through the sixth aspect, the memory controller is further configured to assign one or more priorities to the one or more requests from each of the one or more SoC clients.

In an eighth aspect, in combination with one or more of the first aspect through the seventh aspect, the memory controller is further configured to direct the one or more PIM operations to the PIM unit for execution.

In a ninth aspect, in combination with one or more of the first aspect through the eighth aspect, the translation layer is further configured to store context information for each of the one or more SoC clients, the context information including at least one of temporary accumulator results or register states associated with incomplete PIM operations, identify a switch between PIM operation requests from different SoC clients, and in response to identifying the switch: store current context information for a first SoC client associated with a current PIM operation, retrieve previous context information for a second SoC client associated with a next PIM operation, and restore the retrieved context information for the second SoC client before processing the next PIM operation.

In a tenth aspect, in combination with one or more of the first aspect through the ninth aspect, the translation layer is further configured to combine two or more PIM operation requests from two or more SoC clients into a combined PIM operation, and translate the combined PIM operation into a single set of instructions for the PIM unit.

In an eleventh aspect, a method for operating a memory controller comprising a translation layer, the memory controller operable in an apparatus for virtualizing Process in Memory (PIM) operations, the method includes providing, by the translation layer, one or more virtual process-in-memory (PIM) interfaces, each virtual PIM interface associated with a respective system-on-chip (SoC) client of the apparatus, receiving, by the translation layer, one or more PIM operation requests from one or more SoC clients via the one or more virtual PIM interfaces, and translating, at the translation layer, the received one or more PIM operation requests into one or more PIM operations and interleaving, at the translation layer, the one or more PIM operations.

In a twelfth aspect, in combination with the eleventh aspect, the one or more PIM operation requests include at least one of: a request to write data to a vector register in a PIM unit, a request to perform a multiply-accumulate operation using data stored in the PIM unit, a request to read data from an accumulator register in the PIM unit, a request to perform a matrix-vector multiplication operation, a request to perform an element-wise vector operation, or a request to perform a reduction operation on data stored in the PIM unit.

In a thirteenth aspect, in combination with one or more of the eleventh aspect through the twelfth aspect, the method includes enabling, by the translation layer, a consistent virtual PIM interface to the one or more SoC clients across one or more PIM hardware implementations.

In a fourteenth aspect, in combination with one or more of the eleventh aspect through the thirteenth aspect, the one or more virtual PIM interfaces are configured to accommodate one or more PIM architectures.

In a fifteenth aspect, in combination with one or more of the eleventh aspect through the fourteenth aspect, at least one of the one or more SoC clients includes a central processing unit (CPU), a graphics processing unit (GPU), or a neural processing unit (NPU).

In a sixteenth aspect, in combination with one or more of the eleventh aspect through the fifteenth aspect, the method includes arbitrating one or more requests from each of the one or more SoC clients, and granting access to a PIM unit to each of the one or more SoC clients for a time period.

In a seventeenth aspect, in combination with one or more of the eleventh aspect through the sixteenth aspect, the method includes assigning one or more priorities to the one or more requests from each of the one or more SoC clients.

In an eighteenth aspect, in combination with one or more of the eleventh aspect through the seventeenth aspect, the method includes directing the one or more PIM operations to a PIM unit for execution.

In a nineteenth aspect, in combination with one or more of the eleventh aspect through the eighteenth aspect, the method includes storing context information for the one or more SoC clients, the context information including at least one of accumulator results and register states associated with one or more incomplete PIM operations, detecting a switch between PIM operation requests from different SoC clients, and in response to detecting the switch: storing the context information for a first SoC client associated with a current PIM operation, retrieving previously stored context information for a second SoC client associated with a next PIM operation, and restoring the retrieved context information for the second SoC client before processing the next PIM operation.

In a twentieth aspect, in combination with one or more of the eleventh aspect through the nineteenth aspect, the method includes combining two or more PIM operation requests from two or more SoC clients into a combined PIM operation, and translating the combined PIM operation into a single set of instructions for the PIM unit.

In a twenty-first aspect, an apparatus for virtualizing Process In Memory (PIM) operations includes a system-on-chip (SoC) including one or more SoC clients, a memory controller comprising a translation layer, and a memory device comprising a process-in-memory (PIM) unit and configured for communication with the SoC via the memory controller, wherein the translation layer comprises a context manager configured to store first context information for a first SoC client in response to detecting a switch to a second SoC client, wherein the context information includes at least one of temporary accumulator results or register states associated with PIM operations, retrieve second context information for the second SoC client, store the second context information to the PIM unit before processing a PIM operation request from the second SoC client, and translate the PIM operation request into one or more PIM operations for execution by the PIM unit.

In a twenty-second aspect, an apparatus includes at least one memory storing instructions and one or more processors configured to perform any of the methods of the eleventh aspect through the twentieth aspect.

In a twenty-third aspect, a non-transitory computer-readable medium storing instructions executable by a processor comprises instructions causing the processor to perform any of the methods of the eleventh aspect through the twentieth aspect

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it should be appreciated that throughout this disclosure, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system’s registers and memories into other data similarly represented as physical quantities within the computer system’s registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as, e.g., “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for virtualizing Process In Memory (PIM) operations, comprising:
a system-on-chip (SoC) including one or more SoC clients;
a memory controller comprising a translation layer; and
a memory device comprising a process-in-memory (PIM) unit and configured for communication with the SoC via the memory controller, wherein the translation layer is configured to:
provide one or more virtual PIM interfaces to the one or more SoC clients, wherein the one or more virtual PIM interfaces is associated with the one or more SoC clients;
receive one or more PIM operation requests from the one or more SoC clients via the one or more virtual PIM interfaces; and
translate the received one or more PIM operation requests into one or more PIM operations and interleave the one or more PIM operations.

2. The apparatus of claim 1, wherein the one or more PIM operation requests include at least one of:
a request to write data to a vector register in the PIM unit;
a request to perform a multiply-accumulate operation using data stored in the PIM unit;
a request to read data from an accumulator register in the PIM unit;
a request to perform a matrix-vector multiplication operation;
a request to perform an element-wise vector operation; or
a request to perform a reduction operation on data stored in the PIM unit.

3. The apparatus of claim 1, wherein the translation layer is further configured to enable a consistent virtual PIM interface to the one or more SoC clients across one or more PIM hardware implementations.

4. The apparatus of claim 1, wherein the one or more virtual PIM interfaces are configured to accommodate one or more PIM architectures.

5. The apparatus of claim 1, wherein at least one of the one or more SoC clients includes a central processing unit (CPU), a graphics processing unit (GPU), or a neural processing unit (NPU).

6. The apparatus of claim 1, wherein the memory controller is further configured to:
arbitrate one or more requests from each of the one or more SoC clients; and
grant access to the PIM unit to each of the one or more SoC clients for a time period.

7. The apparatus of claim 6, wherein the memory controller is further configured to:
assign one or more priorities to the one or more requests from each of the one or more SoC clients.

8. The apparatus of claim 1, wherein the memory controller is further configured to direct the one or more PIM operations to the PIM unit for execution.

9. The apparatus of claim 1, wherein interleaving the one or more PIM operations comprises:
storing context information for each of the one or more SoC clients, the context information including at least one of temporary accumulator results or register states associated with incomplete PIM operations;
identifying a switch between PIM operation requests from different SoC clients;
in response to identifying the switch:
storing current context information for a first SoC client associated with a current PIM operation;
retrieving previous context information for a second SoC client associated with a next PIM operation; and
restoring the retrieved context information for the second SoC client before processing the next PIM operation.

10. The apparatus of claim 1, wherein the translation layer is further configured to:
combine two or more PIM operation requests from two or more SoC clients into a combined PIM operation; and
translate the combined PIM operation into a single set of instructions for the PIM unit.

11. A method for operating a memory controller comprising a translation layer, the memory controller operable in an apparatus for virtualizing Process in Memory (PIM) operations, the method comprising:
providing, by the translation layer, one or more virtual process-in-memory (PIM) interfaces, each virtual PIM interface associated with a respective system-on-chip (SoC) client of the apparatus;
receiving, by the translation layer, one or more PIM operation requests from one or more SoC clients via the one or more virtual PIM interfaces; and
translating, at the translation layer, the received one or more PIM operation requests into one or more PIM operations, and interleaving, at the translation layer, the one or more PIM operations”.

12. The method of claim 11, wherein the one or more PIM operation requests include at least one of:
a request to write data to a vector register in a PIM unit;
a request to perform a multiply-accumulate operation using data stored in the PIM unit;
a request to read data from an accumulator register in the PIM unit;
a request to perform a matrix-vector multiplication operation;
a request to perform an element-wise vector operation; or
a request to perform a reduction operation on data stored in the PIM unit.

13. The method of claim 11, further comprising:
enabling, by the translation layer, a consistent virtual PIM interface to the one or more SoC clients across one or more PIM hardware implementations.

14. The method of claim 11, wherein the one or more virtual PIM interfaces are configured to accommodate one or more PIM architectures.

15. The method of claim 11, wherein at least one of the one or more SoC clients includes a central processing unit (CPU), a graphics processing unit (GPU), or a neural processing unit (NPU).

16. The method of claim 11, further comprising:
arbitrating one or more requests from each of the one or more SoC clients; and
granting access to a PIM unit to each of the one or more SoC clients for a time period.

17. The method of claim 16, further comprising:
assigning one or more priorities to the one or more requests from each of the one or more SoC clients.

18. The method of claim 11, further comprising:
directing the one or more PIM operations to a PIM unit for execution.

19. The method of claim 9, further comprising:
storing context information for the one or more SoC clients, the context information including at least one of accumulator results and register states associated with one or more incomplete PIM operations;
detecting a switch between PIM operation requests from different SoC clients; and
in response to detecting the switch:
storing the context information for a first SoC client associated with a current PIM operation;
retrieving previously stored context information for a second SoC client associated with a next PIM operation; and
restoring the retrieved context information for the second SoC client before processing the next PIM operation.

20. The method of claim 9, further comprising:
combining two or more PIM operation requests from two or more SoC clients into a combined PIM operation; and
translating the combined PIM operation into a single set of instructions for the PIM unit.

21. An apparatus for virtualizing Process In Memory (PIM) operations, comprising:
a system-on-chip (SoC) including one or more SoC clients;
a memory controller comprising a translation layer; and
a memory device comprising a process-in-memory (PIM) unit and configured for communication with the SoC via the, wherein the translation layer comprises a context manager configured to:
store first context information for a first SoC client in response to detecting a switch to a second SoC client, wherein the context information includes at least one of temporary accumulator results or register states associated with PIM operations;
retrieve second context information for the second SoC client;
store the second context information to the PIM unit before processing a PIM operation request from the second SoC client; and
translate the PIM operation request into one or more PIM operations for execution by the PIM unit.
